(19) United States
(12) Patent Application Publication
(10) Pub. No.: US 2020/0372553 A1
(43) Pub. Date: Nov. 26, 2020

(54) PERSONALIZED PRODUCT REVIEW SYSTEM

(71) Applicant: eBay Inc., San Jose, CA (US)

(72) Inventors: Surya Manickam Krishna, Bothell, WA (US); Alpha Kamchiu Luk, San Jose, CA (US)

(21) Appl. No.: 16/420,953

(22) Filed: May 23, 2019

(51) Int. Cl. G06Q 30/02; G06F 16/9535

(52) U.S. Cl. CPC G06Q 30/0282; G06F 16/9535

(57) ABSTRACT

Systems, devices, media and methods are presented for generalized a personalized product review sort within an online marketplace. In one example, a system receives from a client device associated with a first user, a request to view an online listing. The system accesses a set of reviews associated with an online listing. The system determines the relevance of each review in the set of reviews based on a correlation between a first user and a second user. The system determines an adjusted rating associated with the online listing and presents the adjusted rating in a graphical user interface of the client device.

### TECHNICAL FIELD

Embodiments of the present disclosure related generally to a personalized product review system. More particularly, but not by way of limitation, the present disclosure addresses systems and method for generating an adjusted rating for an online listing based on one or more reviews associated with the online listing.

### BACKGROUND

Buyers who desire to purchase products in an online marketplace rely on online review of products in determining whether or not to purchase a product. However, fake reviews are becoming increasingly prevalent in contaminating the online marketplaces. As an example, bad actor sellers are paying for fake reviews or are creating fake online accounts to post fake reviews. As a result, product reviews in an online marketplace may not be particularly useful in helping a user to determine whether a product will meet the user's expectations.

### BRIEF DESCRIPTION OF THE DRAWINGS

To easily identify the discussion of any particular element or act, the most significant digit or digits in a reference number refer to the figure number in which that element is first introduced.

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

To easily identify the discussion of any particular element or act, the most significant digit or digits in a reference number refer to the figure number in which that element is first introduced.

FIG. 1 is a block diagram illustrating a networked system including a personalized review application, according to some example embodiments.

FIG. 2 is a system diagram illustrating functional components of a personalized review application, according to some example embodiments.

FIG. 3 is a flow diagram illustrating an example method for generating an ordered set of reviews for an online listing based on a relevance of each review associated with the online listing, according to some example embodiments.

FIG. 4 is a flow diagram illustrating an example method for determining the relevance of a review, according to some example embodiments.

FIG. 5 is a flow diagram illustrating an example method for determining an adjusted rating, according to some example embodiments.

FIG. 6 is a diagrammatic illustration of an interface of an online marketplace application on a computing device, according to some example embodiments.

FIG. 7 is a diagrammatic illustration of an interface of an online marketplace application on a computing device, according to some example embodiments.

FIG. 8 is a diagrammatic illustration of an interface of an online marketplace application on a computing device, according to some example embodiments.

FIG. 9 is diagrammatic illustration of an interface of an online marketplace application on a computing device, according to some example embodiments.

FIG. 10 is a diagrammatic illustration of an interface of an online marketplace application on a computing device, according to some example embodiments.

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Reviews of products in an online marketplace can significantly influence a buyer's decision to purchase a product. Various attributes that are personal to a buyer may be crucial in determining whether or not one review of a product may be more useful to that buyer compared to another review. The following paragraphs describe a method for generating an adjusted rating of a product in an online marketplace based on a similarity between a potential buyer and a reviewing user. This in turn creates a more personalized experience for the potential buyer and increases trust between users within an online marketplace.

Aspects of the present disclosure describes a method for ranking reviews of an online listing in an online marketplace. A review may be an input from a user, quantitative or not, with respect to an online listing. Given a set of reviews associated with an online listing, each review may be ranked based on a relevance of the review. The relevance of the review may be determined by identifying a correlation between a first user viewing the review (e.g., a potential buyer) and a second user who authored the review (also referred to herein as “reviewing user”). In some examples the correlation is determined by identifying an activity correlation in an activity previously performed by a first user viewing the review (e.g., a potential buyer) and with a second user who authored the review (also referred to herein as “reviewing user”). In some examples the correlation is determined by identifying a relationship between the first and second user. The relevance of the review determines the importance of any given review to a first user viewing the review. This relevance may indicate a usefulness of the review to the first user. The ranked reviews are presented to the first user in a graphical user interface of a client device responsive to receiving a request to view an item listing from the client device.

A rating of the online listing may also be associated with each review. An adjusted rating for the online listing may be determined based on the relevance of each review and the rating of each review. The adjusted rating is further presented to the first user in the graphical user interface of the client device.

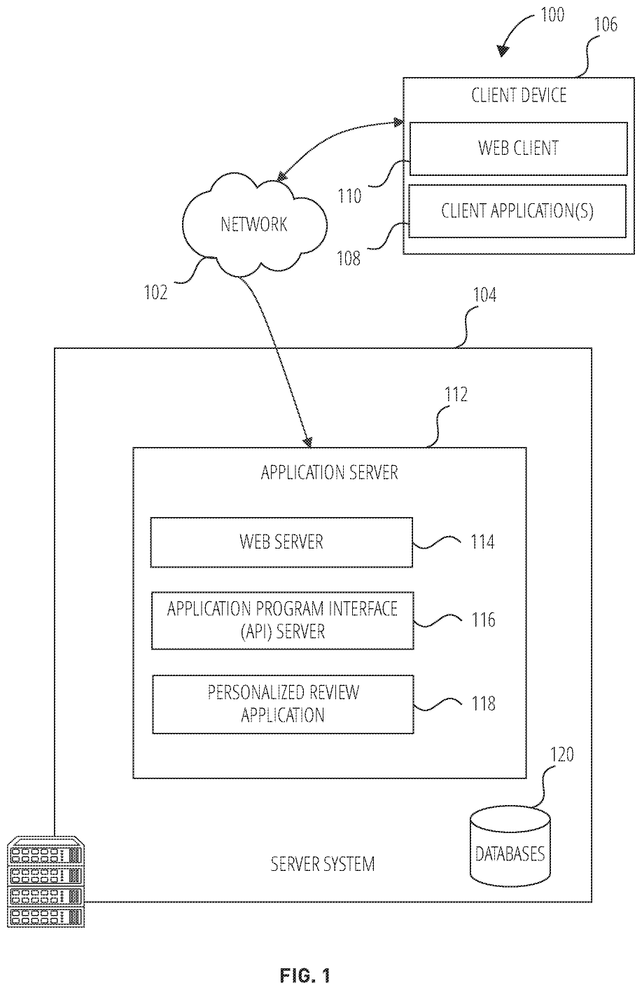

FIG. 1 is a block diagram illustrating a system 100, according to some example embodiments, configured to automatically rank reviews associated with a product in an online marketplace and present the ranked reviews to the first user. The system 100 includes one or more client devices such as client device 106. The client device 106 comprises, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the system 100. In some embodiments, the client device 106 comprises a display module (not shown) to display information (e.g., in the form of user interfaces). In further embodiments, the client device 106 comprises one or more of touch screens, accelerometers, gyroscopes, cameras, microphones, global positioning system (GPS) devices, and so forth. The client device 106 may be a device of a user that is used to access and purchase products from an online marketplace. For example, the client device 106 may be used to input information to create a user profile within an online marketplace, search for online listings, purchase products, draft reviews for products previously purchased, and so forth.

For example, the client device 106 is a device of a given user who would like to purchase a product or service in an online marketplace. Client device 106 accesses a website of an online marketplace (hosted by server system 104). The user inputs search terms relating to the product or service and selects an online listing to view reviews of the product or service in the website. The user selects an option to sort the reviews based on a personalized sort of the reviews. Server system 104 receives the user input and automatically generates a personalized sort of the reviews for the product. In one example, server system 104 retrieves other data specific to the user and each reviewer (e.g., demographic information, purchase history, previous activity within the online marketplace, relationship data). For instance, the server system 104 generates the personalized sort of the reviews based on one or more of the demographic information, purchase history, previous activity, and relationship data of the user and each reviewer within the online marketplace. The ordered set of reviews is provided by the server system 104 to the client device 106. In some examples an adjusted rating for the product or service is provided by the server system 104 to the client device 106.

One or more users may be a person, a machine, or other means of interacting with the client device 106. In example embodiments, the user may not be part of system 100 but may interact with the system 100 via the client device 106 or other means. For instance, the user may provide input (e.g., touch screen input or alphanumeric input) to the client device 106 and the input may be communicated to the entities in the system 100 (e.g., server system 104, etc.) via the network 102. In this instance, the other entities in the system 100, in response to receiving the input from the user, may communicate information to the client device 106 via the network 102 to be presented to the user. In this way, the user interacts with the various entities in the system 100 using the client device 106.

The system 100 further includes a network 102. One or more portions of the network 102 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 106 may access the various data and applications provided by other entities in the system 100 via web client 110 (e.g., a browser) or one or more client application(s) 108. The client device 106 may include one or more client application(s) 108 (also referred to as “apps”) such as, but not limited to, a web browser, messaging application, electronic mail (email) application, an e-commerce site application, a mapping or location application, and the like.

In some embodiments, one or more client application(s) 108 are included in a given one of the client device 106, and configured to locally provide the user interface and at least some of the functionalities, with the client application(s) 108 configured to communicate with other entities in the system 100 (e.g., server system 104, etc.), on an as-needed basis, for data and/or processing capabilities not locally available (e.g., to access location information, to access product information related to the online listing, to authenticate a user, to verify a method of payment, etc.). Conversely, one or more client application(s) 108 may not be included in the client device 106, and then the client device 106 may use its web browser to access the one or more applications hosted on the other entities in the system 100 (e.g., server system 104, etc.). The client application(s) 108 may, for example, be a seller application to enable sellers to author and manage listings on the system 100 in an offline manner, and to perform batch-mode communications between the client application(s) 108 and the server system 104.

A server system 104 provides server-side functionality via the network 102 (e.g., the Internet, or wide area network (WAN)) to one or more client device 106. The server system 104 includes an Application Programming Interface (API) Server 116 a web server 114, and a personalized review application 118, that may be communicatively coupled with one or more databases 120. The one or more databases 120 may be storage devices that store data related to users of the server system 104, applications associated with the server system 104, cloud services, online listing data, and so forth. The one or more databases 120 may further store information related to client device 106, client application(s) 108, users, and so forth. In one example, the one or more databases 120 may be cloud-based storage.

The API server 116 receives and transmits data between the client device 106 and the application server 112. Specifically, the API server 116 provides a set of interfaces (e.g., routines and protocols) that can be called or queried by the client application(s) 108 to invoke functionality of the application server 112. The API server 116 exposes various functions supported by the application server 112 including account registration; login functionality; the sending of messages, via the application server 112 from a particularly client application 108 to another client application 108; the sending of media files (e.g., images or video) from a client application 108 to the personalized review application 118, for possible access by another client application(s) 108; opening an application event (e.g., relating to the client application(s) 108); generating and publishing data items; and so forth. The server system 104 may be a cloud computing environment, according to some example embodiments. The server system 104, and any servers associated with the server system 104, may be associated with a cloud-based application in one example embodiment.

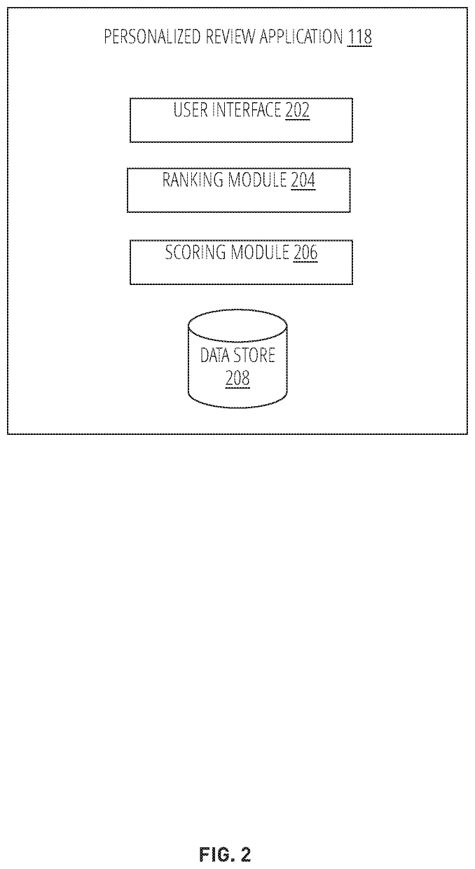

The personalized review application 118 is responsible for determining the order in which reviews associated with an online listing are presented to a user of an online marketplace. The personalized review application 118 obtains one or more reviews of an online listing on an online marketplace. The personalized review application 118 ranks each review based on the relevance of each review, which may indicate a usefulness of the review to a first user. The personalized review application 118 presents an ordered set of reviews to the client device 106. The personalized review application 118 further presents an adjusted rating for the online listing. The adjusted rating is based on the relevance of each review and a rating associated with each review. In one example, the personalized review application 118 comprises or uses a social graph to rank reviews. Though the description that follows addresses only a single review, it shall be appreciated that the operations described below may be repeated for each review in a set of reviews. Further details of the personalized review application 118 are provided below in connection with FIG. 2-FIG. 5.

While the system 100 is illustrated to employ a client-server architecture, the inventive subject matter is, of course, not limited to such an architecture, and could equally well find application in a distributed, or peer-to-peer, architecture system, for example. The personalized review application 118 could also be implemented as standalone software programs, which do not necessarily have networking capabilities.

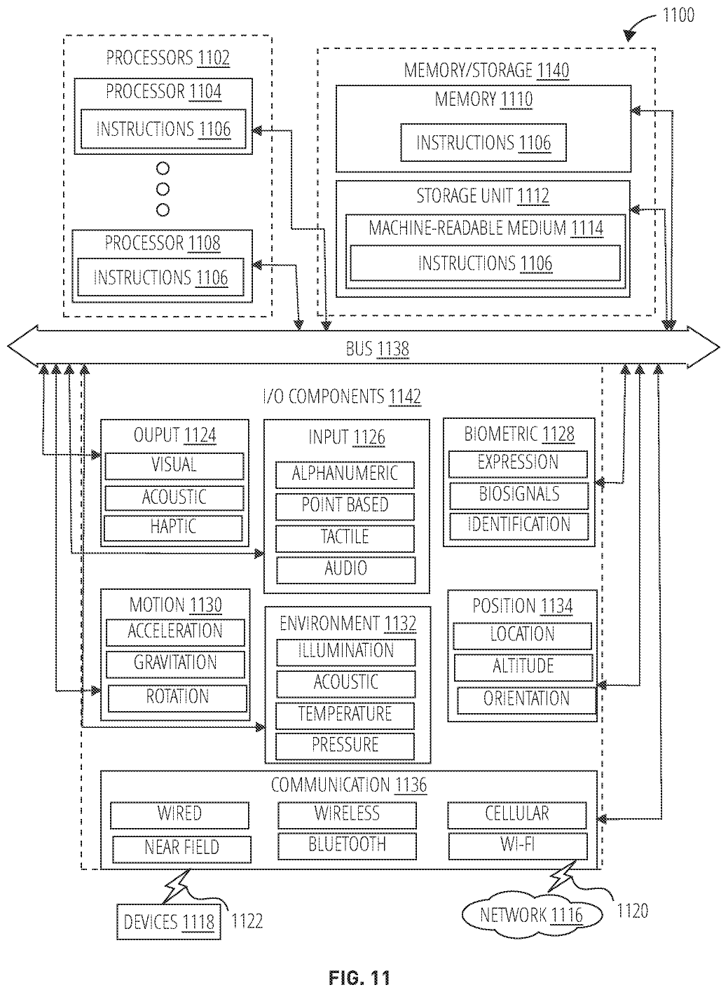

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 11, and such a special-purpose computer may accordingly perform any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the system 100. Furthermore, some components or functions of the system 100 may be combined or located elsewhere in the system 100. For example, some of the functions of the client device 106 may be embodied at the application server 112.

FIG. 2 is a system diagram illustrating functional components of the personalized review application 118, according to some example embodiments. To avoid obscuring the inventive subject matter with unnecessary detail, various functional components (e.g., modules, engines, and databases) that are not germane to conveying an understanding of the inventive subject matter may have been omitted from FIG. 2. However, a skilled artisan will readily recognize that various additional functional components may be supported by the personalized review application 118 to facilitate additional functionality that is not specifically described herein.

As shown, the personalized review application 118 includes a user interface 202, a scoring module 204, a ranking module 206 and a data store 208. The above referenced functional components of the personalized review application 118 are configured to communicate with each other (e.g., via a bus, shared memory, a switch, or APIs). Any one or more of the functional components illustrated in FIG. 2 and described herein may be implemented using hardware (e.g., a processor of a machine) or a combination of hardware and software. For example, any one of the components described herein may configure a processor to perform the operations described herein for that component. Moreover, any two or more of these components may be combined into a single component, and the functions described herein for a single component may be subdivided among multiple components. Furthermore, according to various example embodiments, any of the functional components illustrated in FIG. 2 may be implemented together or separately within a single machine, database, or device or may be distributed across multiple machines, databases, or devices.

The user interface 202 includes one or more APIs that facilitate communication (e.g., exchange of data) between the personalized review application 118 and client application(s) 108, as well as external systems and services. The user interface 202 may receive requests (e.g., requests to generate a personalized review sort) from the client device 106, and communicate appropriate responses (e.g., present an ordered set of reviews) to the client device 106.

The ranking module 204 is configured to present an ordered set of reviews on a user interface of a client device 106. The ranking module 204 ranks the reviews based on the respective relevance of the reviews. The respective relevance of the review may represent the usefulness of each review to a first user viewing the reviews. The usefulness of each review is determined by calculating a similarity score between the first and the second user (e.g., a reviewing user who authored the review) in some example embodiments, the similarity score between the first user and the second user is based on a correlation between the first user and the second user.

The scoring module 206 is configured to determine an adjusted rating of an online listing. The scoring module 206 may determine the adjusted rating based on a relevance of a review and a rating associated with the review. Accordingly, the scoring module 206 determines an adjusted rating associated with an online listing.

The data store 208 includes a computer-readable storage device to store data related to the functioning of the personalized review application 118. For example, the data store 208 may serve as storage for user profiles. The data store 208 may serve as storage for a social graph of users in the online marketplace. For example, the data store 208 may store transaction history, historical review data, demographic data relating to users in an online marketplace.

In some examples, the data store 208 may store user relationship data. User relationship data may describe a number of common user connections between two users in an online marketplace. The user relationship data may be retrieved from one or more social media platforms. The user relationship data retrieved from the social media platforms may describe a number of common connections (e.g., “friends” or “followers”) between two users of the social media platforms. The user relationship data may describe a degree of separation between two users. A degree of separation may measure a social distance between people. For example, if User A is directly connected to both User B and User C, and User B and User C are not directly connected, User A and User B are separated by one degree. User A and User C are also separated by one degree. User B and User C are separated by two degrees.

The personalized review application 118 may comprise or use a social graph to depict relationships between users of the online marketplace. A social graph is a data structure wherein each node in the graph represents a user in the online marketplace and the connecting lines between each node (also referred to as edges), ties or interdependencies are used to map relationships between each user. In some example embodiments, the personalized review application 118 creates a social graph using the data stored in the data store 208. In some example embodiments, the personalized review application 118 imports a previously created social graph from social media websites. The social graph associated with the personalized review application 118 may be analyzed using graph database software. The graph database software allows the personalized review application 118 to analyze the social graph through queries.

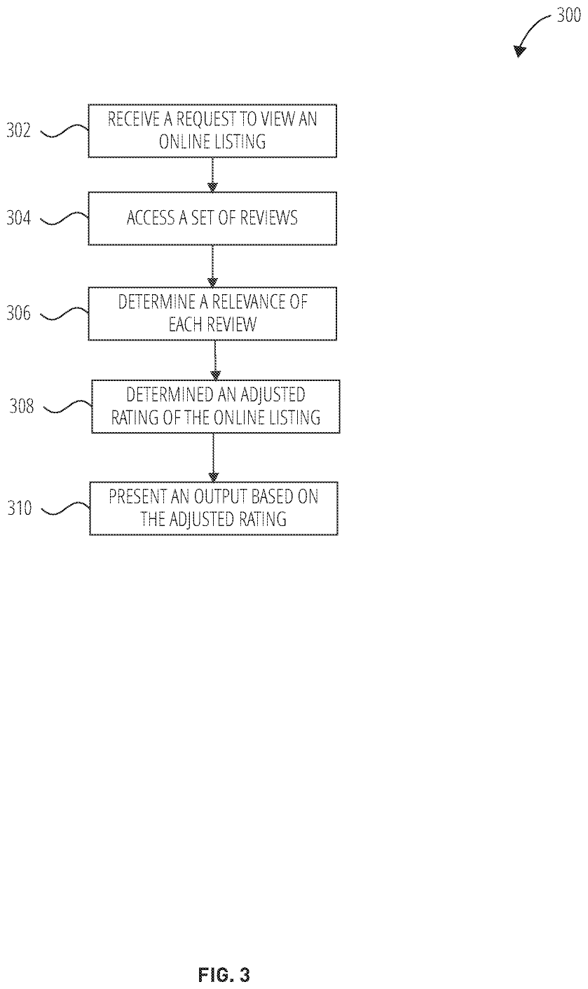

FIG. 3 is a flow diagram illustrating an example method 300 for generating an ordered set of reviews for an online listing (e.g., product) based on a relevance of each review associated with the online listing, according to some example embodiments. In operation 302, the personalized review application 118 receives a request from a client device associated with a first user to view an online listing in an online marketplace. In operation 304, the personalized review application 118 accesses a set of reviews associated with an online listing in the online marketplace. The personalized review application 118 may search through one or more databases 120 to retrieve the set of reviews associated with the listing.

In operation 306 the personalized review application 118 calculates a relevance of each review in the set of reviews. The relevance of a given review indicates how useful the review is to a first user viewing the review based on a relationship of the first user to a second user who authored the review. The relevance may be unique to each first user (e.g., a potential buyer) in the online marketplace.

In operation 306, the personalized review application 118 may utilize the social graph to determine the relevance of each review in the set of reviews. In some embodiments, the personalized review application 118 calculates the relevance of a review based on a relationship between the first user and the second user. For example, the relevance of the review can be based on the distance between nodes in the graph (e.g., first user and second user). The distance between nodes in the graph may be based on the similarity between user profiles associated with the first user and the second user.

In some embodiments, the personalized review application 118 calculates the relevance of a review based on an activity correlation in an activity that was previously performed by the first user and a second user. In one example, the personalized review application 118 obtains activity data from a client device 106. For example, the activity data may include information on any given user's “screen time.” Screen time may comprise information on a user's usage of his or her client device 106, such as how long the user spent using certain types of apps on the client device 106 or how long the user spends using a specific app. Screen time may also comprise information on how often a user visits a specific website or which types of websites the user frequents. The personalized review application 118 may analyze the activity data to identify an activity correlation in an activity that was previously performed by the first user and a second user.

In some embodiments, the personalized review application 118 obtains activity data from one or more databases 120 or via one or more other systems or data sources. For example, the activity data may be obtained by the personalized review application 118 using user profile information associated with the online marketplace. For example, the personalized review application 118 uses the user profile information to search through one or more databases 120 or other sources to retrieve the activity data. The activity data may comprise information regarding the user's transaction history or review history within the online marketplace.

Transaction history may comprise data regarding the products or services purchased by the any given user within the online marketplace. The personalized review application 118 may utilize purchase history by prioritizing reviews written by other users who also purchased the same or similar product or service to the first user.

Review history may comprise previously written reviews by any user within the online marketplace corresponding to previous purchases by the user in the online marketplace. Review history may also comprise previous user feedback associated with existing reviews in the online marketplace. For example, if a user agrees with a review, the user may indicate his or her agreement by selecting a user interface element associated with the review. In another example, if a user disagrees with a review, the user may indicate his or her disagreement by selecting a second user interface element associated with the review.

A user profile may comprise account registration information associated with the online marketplace. A user profile may also comprise demographic data relating to the user. The user may use the client device 106 to input demographic data into his or her user profile within the online marketplace.

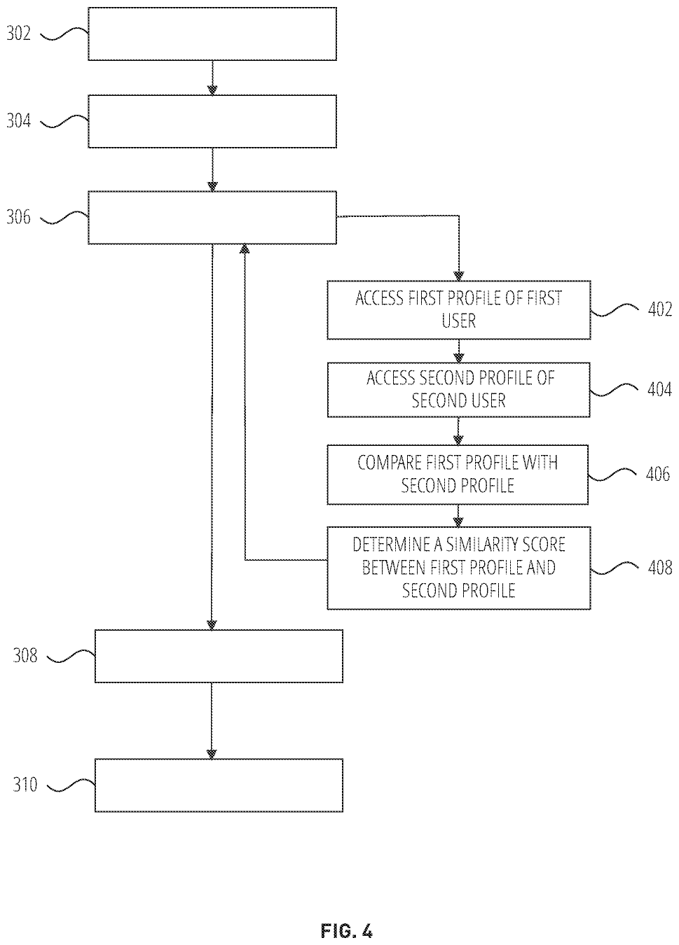

This information in the first user's user profile will be used to compare the first user's user profile with user profiles of other reviewing users within the online marketplace in calculating the relevance of each review. Further details regarding operation 306 are described with respect to FIG. 4 and in the paragraphs further below, according to some example embodiments.

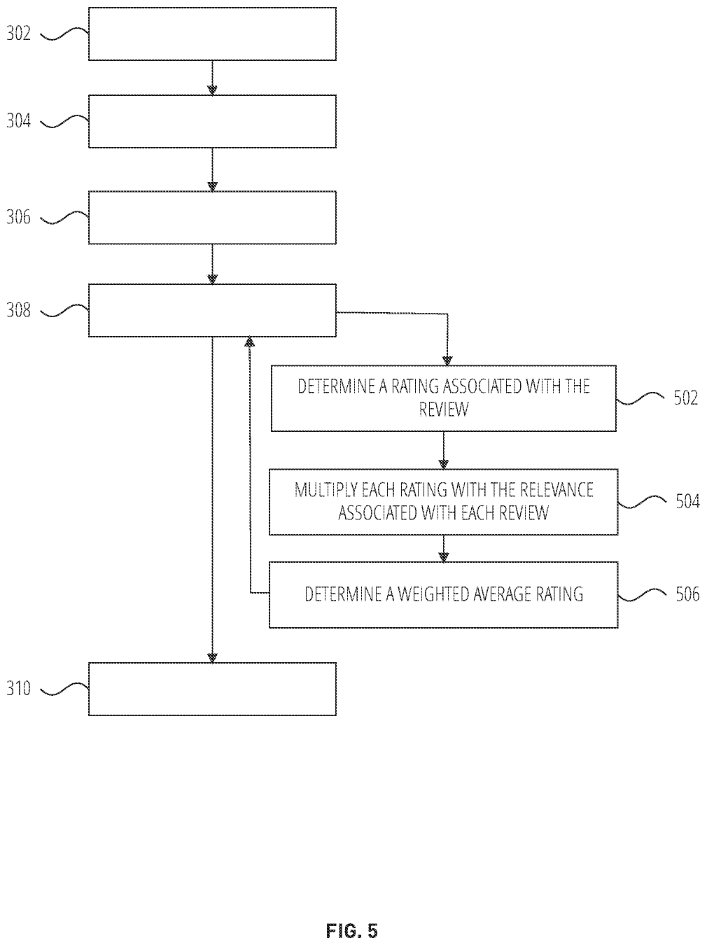

At operation 308, the personalized review application 118 determines an adjusted rating based on the relevance of each review and the rating associated with each review. In some examples, the adjusted rating may represent an adjustment of a rating associated with a review. In these embodiments, the rating of the review is adjusted by multiplying the rating with the relevance of the review. In some examples, the adjusted rating may comprise a weighted average rating (e.g., adjusted aggregate rating) of a rating associated with the online listing. In these embodiments, the adjusted rating is adjusted based on a weighted average of all the reviews associated with the online listing. Further details regarding operation 308 are described in reference to FIG. 5.

At operation 310, the personalized review application 118 causes presentation of an output based on the adjusted rating. In some examples the output comprises the adjusted rating associated with the online listing. For example, the personalized review application 118 may transmit a set of machine-readable instructions to the client device 106 that cause the client device 106 to display the adjusted rating associated with the online listing.

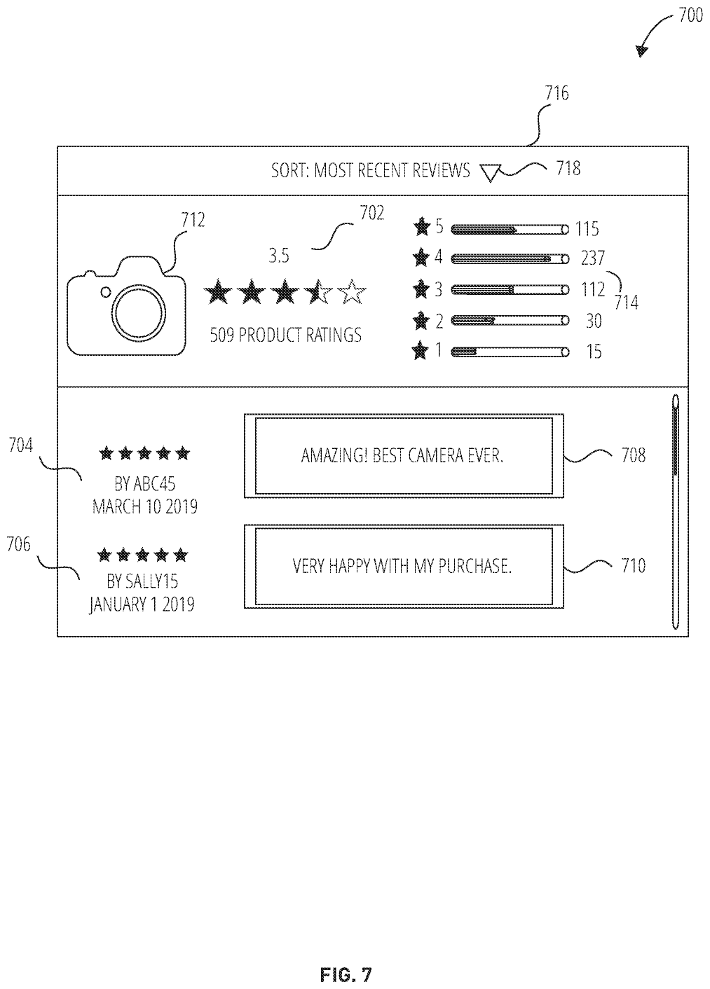

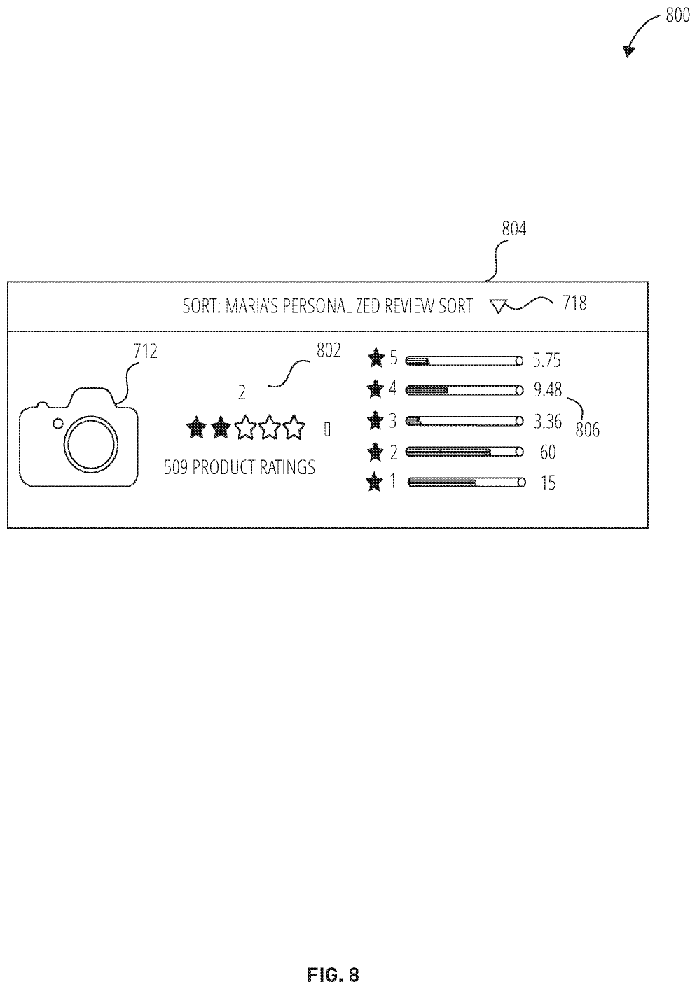

In some examples, the output further comprises an ordered set of reviews based on a ranking of each review. For example, the personalized review application 118 ranks the set of reviews based on the relevance of each review. The personalized review application 118 may rank the set of reviews from highest to lowest relevance. In some examples, the personalized review application 118 causes the client device 106 to display an ordered set of reviews based on the ranking. Further details regarding operation 310 are described below in connection with FIG. 7 and FIG. 8.

In some embodiments, the personalized review application 118 receives a selection from a user interface element presented in conjunction with the online listing in the online marketplace. In response to receiving the selection of the user interface element, the personalized review application 118 causes presentation of the adjusted rating and the ordered set of reviews.

In some embodiments, the personalized review application 118 presents a user interface element in conjunction with each review that describes the relationship between the first user and the second user.

As shown in in FIG. 4, method 300 may, in some embodiments, include operations 402,404, 406 and 408. Consistent with these embodiments, the operations 402, 404, 406 and 408 may be performed as part of the operation 306 where the personalized review application 118 determines a relevance of each review. Though the description that follows addresses only a single review, it shall be appreciated that the operations 402, 404, 406 and 408 may be repeated for each review in the set of reviews accessed at operation 302.

In operation 402, the personalized review application 118 accesses a user profile of the first user. As discussed above, a user profile may comprise activity data relating to the user's usage of a client device 106, transaction history within the online marketplace, and/or review history within the online marketplace. A user profile may also comprise demographic data relating to the user, and relationship data relating to the user.

In operation 404, the personalized review application 118 accesses a second user profile of a reviewing user. In operation 406 the personalized review application 118 compares the first profile with the second profile to identify one or more similarities (e.g., common profile attributes, activities performed by each user, and the like). In operation 408, the personalized review application 118 determines a similarity score between the first profile associated with the first user and a second profile associated with the second user based on the one or more similarities identified from the comparison. The similarity score indicates a degree of similarity between the two profiles.

For example, if a first user and a second user spend a significant amount of time viewing products and services relating to technology and home improvement, then the personalized review application 118 may calculate a high similarity score between the first user's profile and the second user's profile.

In another example, the personalized review application 118 may use review history to prioritize specific types of reviews that the user typically prefers to read. For example, if a first user tends to highly rate longer, and more detailed reviews, the personalized review application 118 may compute a higher similarity score between the first user's profile and a second user's profile that also indicates a preference for lengthier reviews over shorter reviews.

The personalized review application 118 may utilize demographic data to prioritize reviews by other reviewers who are similar in age, gender, income bracket, etc., to the first user. If a first user and a second user are both in their twenties and live in San Francisco, then the personalized review application 118 may determine a high similarity score between the first user's profile and the second user's profile.

In some examples, the personalized review application 118 may use user relationship data in calculating a similarity score. In some embodiments, the similarity score may be based on a number of common connections between a first user and second user. For example, if a first user and a second user have many common “friends” or connections, the personalized review application 118 may determine a high similarity score between the first user's profile and the second user's profile. In some embodiments, the similarity score may be based on a specified degree of separation between the first user and the second user. For example, if the first user and the second user are within a specified degree of separation (e.g., four degrees of separation), the personalized review application 118 may determine a high similarity score between the first user's profile and the second user's profile. In some examples, the specified degree can be determined by the first user. In some examples, the personalized review application 118 may determine a default degree of separation.

In one example embodiment, the similarity score comprises a probability between zero and one that the first profile and the second profile are a match. In another example embodiment, the similarity comprises a threshold value (e.g., 100). For example, if the personalized review application 118 determines a similarity between a first user's profile and a second profile does not exceed a threshold value of 100, then the reviewer's review will not be shown to the first user.

As shown in in FIG. 5, method 300 may, in some embodiments, include operations 502,504 and 506. Consistent with these embodiments, the operations 502, 504 and 506 may be performed as part of the operation 308 where the personalized review application 118 determines an adjusted rating of the online listing.

In operation 502, the personalized review application 118 determines a rating associated with the review. The format of the rating may be predetermined by the service (e.g., provide 1-5 stars, rate your experience as “good, bad or medium”, etc.) The rating of the online listing may be specified by the reviewing user. Accordingly, in determining the rating for the review, the personalized review application 118 may identify the rating specified by the reviewing user in the review. For example, an online marketplace may allow users to rate products or services on a scale from one star to five stars, one star being the lowest score. One reviewer might give a product a four-star rating. Another reviewer might give the product a one-star rating.

In operation 504, the personalized review application 112 multiplies the rating associated with the review with the determined relevance of the corresponding review.

In operation 506, the personalized review application 118 determines a weighted average of all the ratings associated with the online listing. In one example, the weighted average is determined by computing a sum of all the weighted ratings determined in operation 504 and dividing by the total weight.

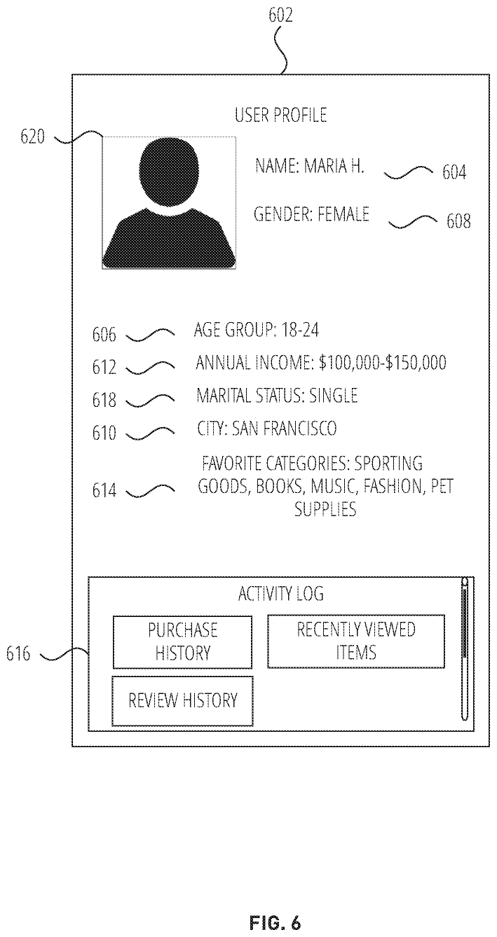

An illustrated example of the output generated by the personalized review application 118 is described in connection with FIG. 6-FIG. 8, below.

FIG. 6 is a diagrammatic illustration of an interface of an online marketplace application on a computing device (e.g., client device 106), according to some example embodiments. The online marketplace application may display an example user profile 602. A user profile 602 may include an image 620 uploaded by the user via the client device 106. The user profile 602 may contain identification information such as the user's name 604. The user profile 602 may also contain demographic information such as gender 608, age group 606, annual income 612, marital status 618, city of residence 610, favorite shopping favorite shopping categories 614, and the like.

The user profile 602 may also include an activity log 616. The activity log 616 may include purchase history, review history, and other activity related information such as recently viewed items.

FIG. 7 is a diagrammatic illustration of an interface 700 of an online marketplace application on a computing device (e.g., client device 106), according to some example embodiments. As shown, a first user (e.g., a potential buyer) in an online marketplace may be provided with several options to sort existing reviews for an online listing. For example, a first user may select user interface element 718 to sort reviews by most recent reviews 716. An image of a product 712 may be depicted in conjunction with its average rating 702. In some example embodiments, a brief description of the product 712 may also be depicted in conjunction with the image of the product 712. A detailed breakdown 714 of the average rating 702 may also be provided within the interface 700. In the example illustrated in FIG. 7, the first user has opted to sort reviews by most recent reviews 716, and as a result, the most recent review 708 written by reviewing user 704 is listed first, followed by the second most recent review 710 written by reviewing user 706.

FIG. 8 is a diagrammatic illustration of an interface 800 of an online marketplace application on a computing device (e.g., client device according to some example embodiments. A first user in an online marketplace may select the user interface element 718 to initiate a personalized review sort 804. The personalized review sort 804 presents to the first user, an adjusted rating 802 associated with the online listing. The adjusted rating 802 may be unique to each individual user in the marketplace.

For example, although the average rating 702 depicted in FIG. 7 for the product 712 was 3.5 stars, the personalized review sort 804 generates an adjusted rating 802 based on the relevance of each review and the rating associated with each review. For example, if the personalized review application 118 determined that all 115 of the 5 star reviews, 237 4 star reviews and 112 3 star reviews were given a relevance of 0.01, all 30 of the 2 star ratings were given a relevance of 1 and all 15 the 1 star ratings were given a relevance of 0.96, the personalized review application 112 calculates an adjusted rating 802 of approximately 2 stars. The calculation below is an example calculation of the adjusted rating 802:

((115×5×0.01)+(237×4×0.01)+(112×3×0.01)+(30×2×1)+(15×1×0.96))/((115×0.01)+(237×0.01)+112×0.01)+(30×1)+(15×0.96))

Thus, in this example, the adjusted rating 802 is 1.89 stars, which may be rounded up to 2 stars. The personalized review sort 804 further prompts the personalized review application 118 to present an adjusted detailed breakdown 806 of the adjusted rating 802 within the interface 800.

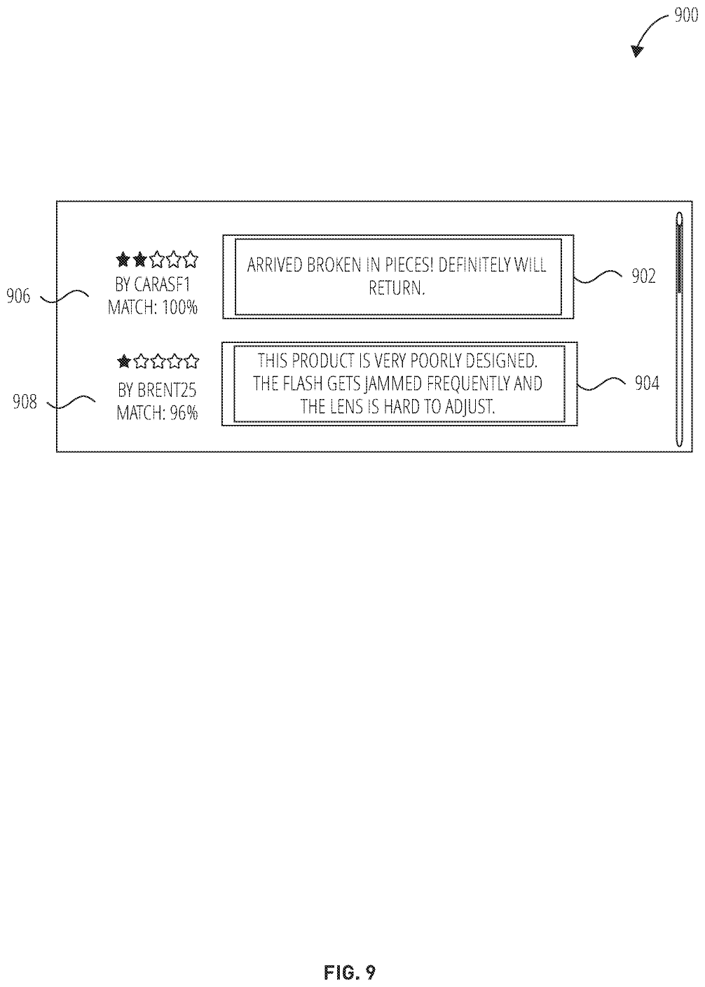

FIG. 9 is a diagrammatic illustration of an interface 900 of an online marketplace application on a computing device (e.g., client device), according to some example embodiments. The personalized review sort 804 may further sort reviews to generate a ranked list of reviews based on one or more correlations between the first user and the reviewing users.

The personalized review sort 804 presents the review 902 with the higher relevance, written by the reviewing user 906 who is more similar to the first user followed by the review 904 with a lower relevance written by the reviewing user 908 who is relatively less similar to the first user. A description of the relevance of the relationship between the first user and the reviewing user 906 and reviewing user 908 may also be depicted within the user interface (e.g., Match: 100%, Match: 96%). Therefore, unlike sorting by the most recent reviews 716, the personalized review sort 804 ranks reviews based on the relevance of each review and provides an adjusted rating 802 based on the relevance of each review and the rating associated with each review.

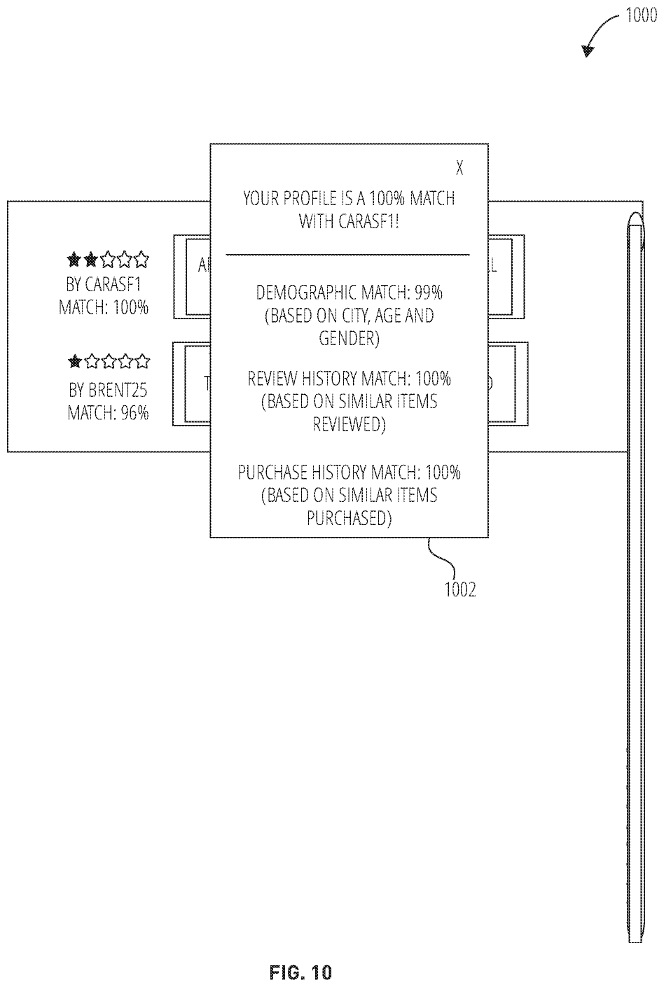

FIG. 10 is a diagrammatic illustration of an interface 1000 of an online marketplace application on a computing device (e.g., client device), according to some example embodiments. In some examples, the first user (e.g., the buyer) may select a review (e.g., review 902, review 904) to reveal how the personalized review application 118 determined the match percentage (e.g., Match: 100%, Match 96% as shown in FIG. 9). The personalized review application 118 may display a window 1002 which reveals how the profile match percentage was calculated. In some examples, the profile match percentage may be based on the similarity of the demographic data, review history data and/or purchase history data between the first user and the second user. In some examples, the personalized review application 118 may reveal a percentage of demographic data, review history data and/or purchase history data that the first user and the second user have in common. The personalized review application 118 may further display a list of the specific demographic data, review history data and/or purchase history data that the first user and the second user have in common. For example, the personalized review application 118 may reveal specific items that the first user and the second user have both previously viewed or the specific items that the first user and the second user have both previously purchased. The foregoing data may be pulled, for example, from the user profile as shown in FIG. 6.

Certain embodiments are described herein as including logic or a number of components, modules, or mechanisms. Modules may constitute either software modules (e.g., code embodied on a non-transitory machine-readable medium) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special-purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Hardware Architecture

FIG. 11 is a block diagram illustrating components of a machine 1100, according to some example embodiments, able to read instructions 1106 from a machine-readable medium 1114 (e.g., a machine-readable storage medium) and perform any one or more of the methodologies discussed herein. Specifically, FIG. 11 shows a diagrammatic representation of the machine 1100 in the example form of a computer system, within which instructions 1106 software, a program, an application, an apples, an app, or other executable code) for causing the machine 1100 to perform any one or more of the methodologies discussed herein may be executed. As such, the instructions 1106 may be used to implement modules or components described herein. The instructions 1106 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1100 capable of executing the instructions 1106, sequentially or otherwise, that specify actions to be taken by machine 1100. Further, while only a single machine 1100 is illustrated, the term “machine” shall also be taken to include a collection of machines that individually or jointly execute the instructions 1106 to perform any one or more of the methodologies discussed herein.

The machine 1100 may include processors 1102 (e.g., processor 1104, processor 1108), memory/storage 1140, and I/O components 1142, which may be configured to communicate with each other such as via a bus 1138. The memory/storage 1140 may include a memory 1110, such as a main memory, or other memory storage, and a storage unit 1112, both accessible to the processors 1102 via the bus 1138. The storage unit 1112 and memory 1110 store the instructions 1106 embodying any one or more of the methodologies or functions described herein. The instructions 1106 may also reside, completely or partially, within the memory 1110, within the storage unit 1112, within at least one of the processors 1102 (e.g., within the processor's cache memory), or any suitable combination thereof, during execution thereof by the machine 1100. Accordingly, the memory 1110, the storage unit 1112, and the memory of processors 1102 are examples of machine-readable media.

The I/O components 1142 may include a wide variety of components to receive input, provide output, produce output, transmit information, exchange information, capture measurements, and so on. The specific I/O components 1142 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1142 may include many other components that are not shown in FIG. 11. The I/O components 1142 are grouped according to functionality merely for simplifying the following discussion and the grouping is in no way limiting. In various example embodiments, the I/O components 1142 may include output components 1124 and input components 1126. The output components 1124 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1126 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components a microphone), and the like.

In further example embodiments, the I/O components 1142 may include biometric components 1128, motion components 1130, environmental components 1132, or position components 1134 among a wide array of other components. For example, the biometric components 1128 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1130 may include acceleration sensor components (e.g., accelerometer), gravitation sensor components, rotation sensor components (e.g., gyroscope), and so forth. The environmental components 1132 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1134 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1142 may include communication components 1136 operable to couple the machine 1100 to a network 1116 or devices 1118 via coupling 1120 and coupling 1122, respectively. For example, the communication components 1136 may include a network interface component or other suitable device to interface with the network 1116. In further examples, communication components 1136 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1118 may be another machine or any of a wide variety of peripheral devices (e.g., a peripheral device coupled via a USB).

Moreover, the communication components 1136 may detect identifiers or include components operable to detect identifiers. For example, the communication components 1136 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as, location via Internet Protocol (IP) geo-location, location via Wi-Fi® signal triangulation, location via detecting a NFC beacon signal that may indicate a particular location, and so forth.

### Executable Instructions and Machine Storage Medium

The various memories (1140, 1110, and/or memory of the processors 1102) and/or storage unit 1112 may store one or more sets of instructions and data structures (e.g., software) embodying or utilized by any one or more of the methodologies or functions described herein. These instructions (e.g., the instructions 1106), when executed by processors 1102, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1116 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1116, or a portion of the network 1116 may include a wireless or cellular network, and the coupling 1120 may be a Code Division Multiple Access (CDMA) connection, a Global System for Mobile communications (GSM) connection, or another type of cellular or wireless coupling. In this example, the coupling 1120 may implement any of a variety of types of data transfer technology, such as Single Carrier Radio Transmission Technology (1×RTT), Evolution-Data Optimized (ENDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1106 may be transmitted or received over the network 1116 using a transmission medium via a network interface device (e.g., a network interface component included in the communication components 1136) and utilizing any one of a number of well-known transfer protocols (e.g., hypertext transfer protocol (HTTP)). Similarly, the instructions 1106 may be transmitted or received using a transmission medium via the coupling 1122 (e.g., a peer-to-peer coupling) to the devices 1118. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1106 for execution by the machine 1100, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a client device associated with a first user, a request to view an online listing;
based on receiving the request, accessing a set of reviews associated with the online listing;
determining a relevance of each review in the set of reviews, the determining of the relevance of each review comprising determining a relevance of a review in the set of reviews based on a correlation between a first user and a second user who authored the review, the review comprising a rating;
determining an adjusted rating based in part on the relevance of the review and the rating; and
causing presentation, in a graphical user interface displayed by the client device, of an output based on the adjusted rating.

2. The method of claim 1, wherein the adjusted rating comprises an adjustment to the rating of the first review.

3. The method of claim 1, wherein the adjusted rating comprises an adjusted aggregate rating associated with the online listing.

4. The method of claim 1, wherein the output comprises the adjusted rating.

5. The method of claim 4, wherein the output further comprises a ranked list of reviews based on the relevance of each review in the set of reviews.

6. The method of claim 1, further comprising:
accessing a first profile corresponding to the first user;
accessing a second profile corresponding to the second user;
comparing the first profile with the second profile; and
determining a similarity score between the first profile and the second profile, wherein the relevance of the review is based on the similarity score.

7. The method of claim 6, wherein the similarity score comprises a numerical value between zero and one.

8. The method of claim 6 wherein the first profile and the second profile comprise historical review data.

9. The method of claim 6, wherein the first profile and the second profile comprise user demographic data.

10. The method of claim 1, wherein the correlation between the first user and the second user is an activity correlation in an activity previously performed by the first user and the second user.

11. The method of claim 10, wherein the activity is associated with a review history of a third online listing corresponding to previous user feedback associated with a previous review corresponding to the third online listing.

12. The method of claim 1, further comprising:
receiving input indicative of a selection of a user interface element presented in conjunction with the online listing; and
wherein the presenting of the ordered set of reviews is in response to receiving the selection.

13. The method of claim 1, wherein a first review in the set of reviews is associated with a first reviewing user in the set of reviewing users, the method further comprising:
presenting a user interface element in conjunction with the first review comprising a description of the relationship between the user and the first reviewing user.

14. A system comprising:
a processor; and
a memory storing instructions that, when executed by the processor, configure the system to perform operations comprising:
receiving, from a client device associated with a first user, a request to view an online listing;
based on receiving the request, accessing a set of reviews associated with the online listing;
determining a relevance of each review in the set of reviews, the determining of the relevance of each review comprising determining a relevance of a review in the set of reviews based on a correlation between a first user and a second user who authored the review, the review comprising a rating;
determining an adjusted rating based in part on the relevance of the review and the rating; and
causing presentation, in a graphical user interface displayed by the client device, of an output based on the adjusted rating.

15. The system of claim 14, wherein the adjusted rating comprises an adjustment to the rating of the first review.

16. The system of claim 14, wherein the rating is a numerical value specified by the reviewing user.

17. The system of claim 14, further comprising:
accessing a first profile corresponding to the first user;
accessing a second profile corresponding to the second user;
comparing the first profile with the second profile; and
determining a similarity score between the first profile and the second profile, wherein the relevance of the review is based on the similarity score.

18. The system of claim 17, wherein the similarity score comprises a numerical value between zero and one.

19. The system of claim 17, wherein the first profile and the second profile comprise historical review data.

20. A non-transitory computer-readable storage medium, the computer-readable storage medium including instructions that when executed by a computer, cause the computer to perform operations comprising:
receiving, from a client device associated with a first user, a request to view an online listing;
based on receiving the request, accessing a set of reviews associated with the online listing;
determining a relevance of each review in the set of reviews, the determining of the relevance of each review comprising determining a relevance of a review in the set of reviews based on a correlation between a first user and a second user who authored the review, the review comprising a rating;
determining an adjusted rating based in part on the relevance of the review and the rating; and
causing presentation, in a graphical user interface displayed by the client device, of an output based on the adjusted rating.
